(19) United States
(12) Patent Application Publication
(10) Pub. No.: US 2002/0030012 A1
(43) Pub. Date: Mar. 14, 2002

(54) Comprehensive waste treatment system and related methods for animal feeding operations to effectively recover waste solids for beneficial re-use and for treatment of wastewater for nutrient removal and recycle, re-use or discharge

(76) Inventors: John Michael Sullivan, Rancho Murieta, CA (US); Gregg Anthony Crocco, Sacramento, CA (US)

Correspondence Address: JOHN M. SULLIVAN, 7082 MURIETA PARKWAY, P.O. Box 1230, RANCHO MURIETA, CA, 95683, US

(21) Appl. No.: 09/837,924

(22) Filed: Apr. 18, 2001

Related U.S. Application Data
(60) Provisional application No. 60/198,409, filed on Apr. 19, 2000.

(51) Int. Cl. C02F 1/58

(52) U.S. Cl. 210/631; 210/705; 210/709; 210/724; 210/743; 210/195.1; 210/712; 210/199; 210/202

(57) ABSTRACT

A process is provided to create a treated recycle stream through pre-treatment and solids separation for reuse in animal feeding operations without odors and creates a treated liquid effluent that can be stored for reuse, or can be land applied without odors and is free from pathogens and nutrients. Additionally the methods describe a means of converting animal manure to organic fertilizer and removing nutrients from the liquids to create a feed supplement from biomass. The organic fertilizer is non-leaching and free from pathogens. The entire process is accomplished in a reduced footprint from other treatment processes and allows waste ponds to be removed from service.

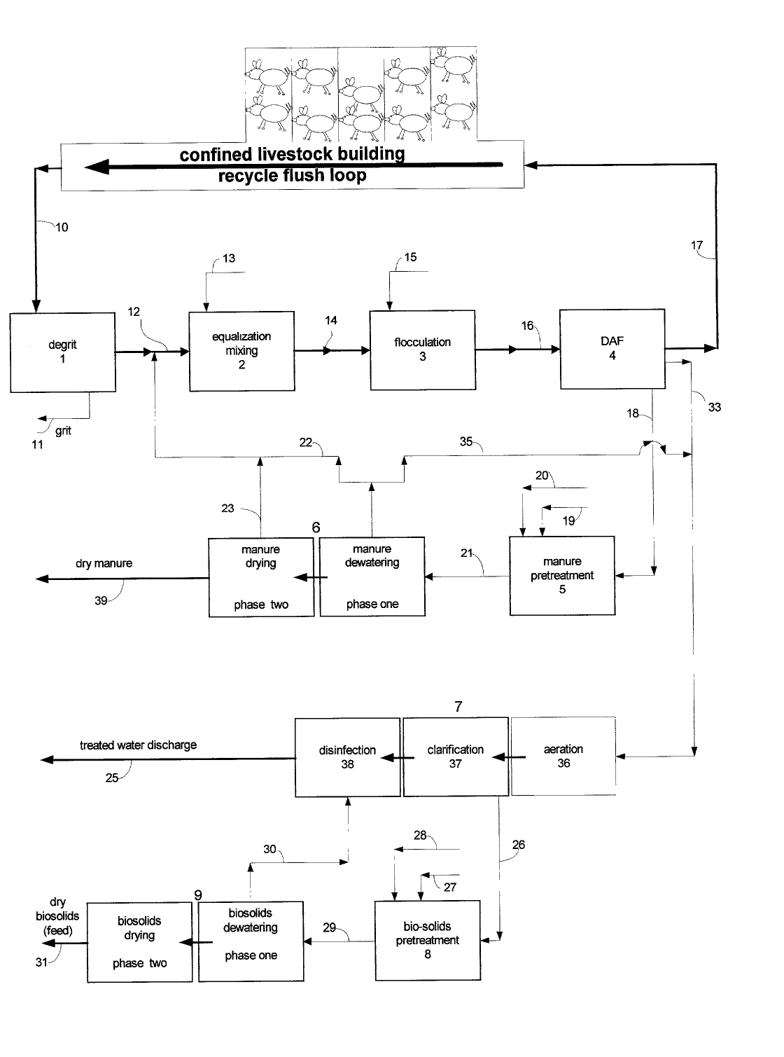

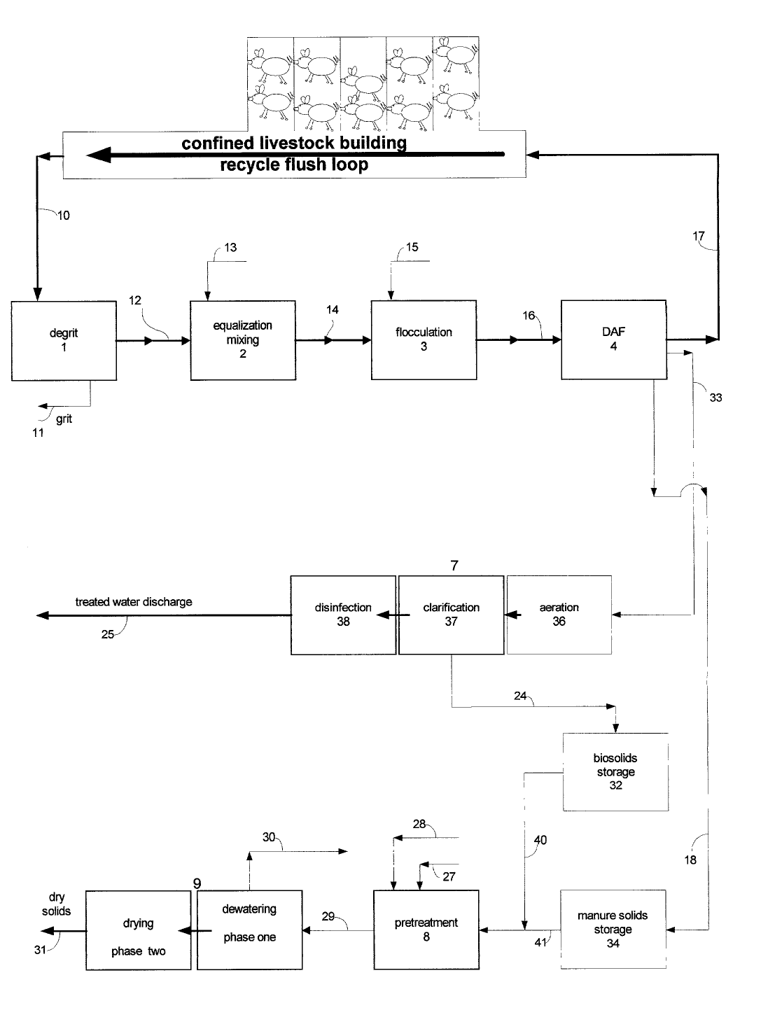

### CROSS-REFERENCE TO RELATED APPLICATIONS

This application claims benefit of U.S. Provisional Application Ser. No. 60/198,409 filed Apr. 19, 2000, and is incorporated herein by reference.

### STATEMENT REGARDING FEDERAL SPONSORED RESEARCH AND DEVELOPMENT

There are no rights to the invention by virtue of any federally sponsored research and development.

### U.S. CLASSIFICATIONS

205/; 210/710; 210/601; 210/703; 210/702; 210/712; 210/713; 210/749; 210/768; 210/925; 210/923; 210/198.1; 210/167; 210/205; 210/422; 209/5; 405/52; 405/; 071/25; 436/43; 071/; 023/293R; 122/; 034/; 034/70; 205/751;

### BACKGROUND OF THE INVENTION

The livestock industry has undergone dramatic changes in the past 20 years. The continuing trend toward fewer but larger operations, coupled with greater emphasis on more intensive production methods is concentrating more animals and manure waste constituents within some geographical areas. An estimated 376,000 livestock operations confine animals in the United States. These operations generate about 64 million tons of manure each year.

Animal feeding operations (AFO) generate wastes that can cause many associated environmental problems. Currently, most agricultural facilities use anaerobic digestion for treatment of ponds and wastewater. The primary reasons for using anaerobic digestion is simplicity and cost. Wastewater is discharged from the animal feeding facility into an open lagoon or through a sedimentation basin to separate solids and then into an open lagoon (waste storage ponds) or plurality of lagoons where the waste undergoes natural anaerobic digestion. After retention in the lagoon system, wastewater is usually land applied via spray irrigation. Some of the supernatant is re-circulated as wash down water or for waste fluming of under floor drains which collect manure and urine from the livestock buildings or standing areas. The method used to transfer the waste depends largely on its consistency and the type of operation. One of the issues associated with these wastes is storing of untreated liquids and solid wastes with their associated smells and risk of spills or unanticipated releases. Odors associated with animal feeding operations are both nuisances and health concerns for animals, workers and neighbors. Poor nutrient management methods have lead to many uncontrolled spills of animal wastes, and has resulted in millions of dollars in damage claims against farm operators and family farmers. These spills and releases affect animals, plants, fish and humans. Pathogens associated with these spills have been blamed for millions of dollars in damages. The traditional water recycle and treatment methods being utilized by animal feeding operations, results in excess waste storage requirements and highly contaminated flush water with excessive concentrations of ammonia, biochemical oxygen demand (BOD), toxic sulfur compounds, toxic organic compounds, phosphates and pathogens.

Pollutants from agricultural sources are the most common types of contaminants found in U.S. rivers and streams according to the Environmental Protection Agency. Manure, and other waste from livestock operations is a main contributor to this pollution problem. According to the 1998 National Water Quality Inventory, approximately 60 percent of the pollution in rivers and streams, and 45 percent of lake pollution, comes from agricultural sources. Runoff from livestock operations enters water bodies when poor maintenance of waste lagoons, improper design of storage structures, hurricanes or excessive rainfall result in spills or leaks of manure-laden water. Over-application of manure to cropland is another source of animal waste runoff. When animal wastewater or manure infiltrates ground water it can create an immediate threat to public health and valuable water resources. This runoff has nutrients such as nitrogen and phosphorus that in excess, cause algae and other microorganisms to reproduce in waterways, creating unsightly and harmful algae blooms which can lower the level of dissolved oxygen (DO) in the water, and which can cause fish and other aquatic organisms to die. Spills from ruptured waste lagoons have killed millions of fish. Animal waste runoff can also be a threat to the health of people who come in contact with affected waters because some of the microbes (bacteria, protozoa, and viruses) in animal waste can cause human diseases.

Over forty noxious gases may be emitted from anaerobic lagoons at hog or dairy farms including ammonia, methane, and hydrogen sulfide. Additionally, the time required for digestion of the organic wastes is relatively long, from weeks to months. Neighbors find odors emanating from lagoons, confinement houses, and fields onto which wastes are sprayed, to be a nuisance. Concerned States have mandated buffer zones in populated areas. In certain instances, the reduction of organics and nutrients within an anaerobic lagoon is minimal and high concentrations of nitrogen and phosphorus end up being applied to the land during spray irrigation in excess of the ergonomic rate.

Even with bacterial digestion within an anaerobic lagoon, significant amounts of sludge accumulate at the bottom of the storage pond. Lagoons may fill to capacity fairly quickly which displaces the designed retention capacity of the storage pond and tends to short circuit the treatment processes and provide only partial treatment of wastes.

The present invention combines a series of processes and methods with wide ranging advantages over current methods and processes. An extensive listing of prior art shows that in U.S. Pat. No. 5,863,434 stabilizing manure slurries through anaerobic digestion in sequencing batch reactors for gas production is described, without mention of solids dewatering. In U.S. Pat. No. 5,545,325 the largest fraction of water use in livestock operations for recycle flushing is not mentioned, and treatment is presumably performed on waste through aerobic treatment, which merely takes a portion of the problem in hand. No mention of solids handling is made in U.S. Pat. No. 6,054,044 that describes biological treatment for liquids and solids, with water returned for flushing. In U.S. Pat. No. 6,083,386 chlorination and filtration are presumably used to remove nitrogen. This process claims to remove BOD and nitrogen, returning the water to drinking water quality, with no mention of the salt concentrating up in the wastewater. It seems that fermentation, incineration, lime stabilization, composting, gasification, thermo-compression, microwave, electrically ionizing, pelletizing, bombardment with radio frequency waves, and many combinations of the above along with ozone treatment, UV, biological treatment, clarification, pH treatments, thermal drying, and conversion to ethanol have, and are being proposed to solve the problems associated with animal wastes or the removal of treatment ponds from the equation.

In order to remove ponds from animal feeding operations, there still remains the need to transport the animal manure and wet wastes away from the livestock feeding areas. The least cost method of achieving this is by waste fluming. It is interesting to note that more than 30,000 concentrated animal feeding operations are already constructed. If waste ponds are eliminated and the current waste transporting method (by fluming) were made unavailable, the current design of confined animal facilities would be rendered nearly useless. In large operations, liquids are used to perform the waste fluming function, by transporting wastes from pits or channel drains under floor out of the livestock building or sedimentation basins adjacent to or below them. This contaminated water can be more than twenty-five times the volume of the fresh water consumed by the animals for drinking.

It is with this background that the invention was developed.

### BRIEF SUMMARY OF THE INVENTION

As many as 39,000 concentrated animal feeding operations (CAFOs) are the subject to guidelines developed by the Environmental Protection Agency (EPA) and the U.S. Department of Agriculture (USDA), as outlined in a Unified National Strategy for Animal Feeding Operations. In addition to Federal regulations and rules, certain States and municipalities are implementing stricter rules and regulations under their own permitting authority to limit where operators can construct or expand animal feeding operations. North Carolina currently has a moratorium on construction of waste lagoons for storage of animal wastes, and is actively seeking a method of treating wastes without use of waste ponds for storage. The sensitivity of Concentrated Animal Feeding Operations was recently highlighted when an Environmental Impact Report was required before a proposed dairy development would be considered within a primarily agricultural County in the largest agricultural and dairy state, California.

Certain animal feeding operations are defined as point sources of pollution by EPA and are subject to NPDES (National Pollution Discharge Elimination System) regulations, and may be required to file site-specific comprehensive nutrient plans (CPNP). Although the NPDES regulation identifies who needs a permit, the effluent guidelines establish national requirements regarding the types and amount of pollutants a permitted concentrated animal feeding operation (CAFO) with a minimum of 1,000 or more animal units (AU) is allowed to discharge. EPA established the effluent guidelines for feedlots in 1974 based on the best technology available that was economically feasible at that time for the industry. Since then inconsistent interpretation of regulations by states and federal regulators has resulted in inadequate enforcement and compliance. Public concern, changes in the livestock industry, persistent water quality problems, and public health risks have demonstrated the need for waste treatment systems that deal with the wide variety of issues that present themselves when waste treatment becomes the over riding concern, before operations are expanded or even permitted. It is with this background that the invention was developed to effectively treat the manure and wastewater from animal feeding operations.

The initial process within the invention addresses this requirement, by removing enough solids and liquids from the system to maintain a water balance while continuously pretreating and making available the liquid fraction of the wastewater in a loop, to refill tanks which store water being recycled for waste fluming. In most animal feeding operations this waste fluming is going on twenty-four hours a day. By removing the manure solids, all non-floatable solids, and the use of a dissolved air flotation (DAF) device which is properly monitoring and adjusting for pH with the addition of metal-salts, this recycle stream is predominately free of solids and objectionable odor. Since dissolved oxygen (DO) is present in this conditioned flush water, anaerobic degradation will not produce reduced sulfur compounds, organic acids or ptomaine type compounds, which are the major odor producing elements in the nuisance profile. The solids/liquid mixture being floated in the DAF unit is transferred to a batch storage tank. Odors are dramatically reduced or eliminated with this simple system and methods.

For more diluted wastes, as in dairy operations, where recycle water is a smaller fraction of the total water used on a continuous basis, the means of creating the recycle stream will include biological treatment for all of the liquids leaving the animal feeding operation. The resultant treated liquid stream would then be stored as a source of re-use water, agricultural irrigation water, or can be discharged. As before, the streams rejected from the production of this recycle water (i.e. manure slurry and biosolids), will be further processed to maximize their value based on the operators requirements or regulatory compliance.

The second process within the invention takes this solids/liquid mixture transferred from the DAF, and processes it into (organic) fertilizer. After transfer of the solids/liquid mixture from the DAF to a batch mix-tank, the slurry is conditioned to aid in the dewatering process. The conditioning chemicals, calcium, iron, magnesium, sulfur and phosphorous in addition to pH adjustments are used in this step to amend the final composition of the dried fertilizer product. Prospectively, this second process could produce an organic fertilizer. As the USDA organic fertilizer regulations are implemented over the next decade, this organic product could be a valuable revenue source for farm operators.

The conditioned slurry is dewatered, disinfected and dried using a vacuum filter press (VFP). The liquid fraction removed in this second process (filtrate or effluent), requires further treatment to remove nutrients and Biochemical Oxygen Demand (BOD), which is removed in the next step.

The soluble BOD and soluble nutrients remaining in the liquid effluent from the reject overflow is treated using biological treatment, converting these nutrients in the liquid fraction to a protein rich biomass. The biological treatment system's primary function is to treat the water to the desired treatment specification, while maximizing the biomass (by weight), and reducing BOD and nutrients. The treatment level in each system can vary to meet the operator's requirements for either irrigation needs, re-use and recycle, storage or discharge. The level of treatment may vary from meeting NPDES (national pollution discharge elimination system) permit requirements, to tertiary re-use standards or simply for agricultural irrigation requirements. If warranted or justified, from a cost standpoint, salt removal techniques could be employed by use of membrane filtration, or other advanced post-treatment processes. [Salts, within animal wastewater is a growing concern, as over time, salt concentrations in the soil damage crop yields. Little attention is paid to this issue in prior art.] The solids developed from the biological treatment system are handled in the fourth process within the invention.

The final process step, dewaters, dries and disinfects the protein rich single cell bacteria (biomass) by utilizing the VFP technology. The types of pre-treatments used can be adjusted depending on the type of feed material required. Although the dried biosolids has a higher value as a feed material, the slurry could be dewatered and dried along with the manure solids generated in the second phase of the process, although in the preferred embodiment we describe the two process trains separately. This is because the perception and therefore the relative values of these two products are so variable based on geography and market conditions.

A central objective of the preferred embodiment of the invention is to eliminate the impoundments of untreated or partially treated wastes in ponds.

An additional objective of the invention is to essentially eliminate ammonia emissions from the animal feeding operations and to eliminate off-site odors from occurring from land application of untreated wastes. The invention essentially eliminates hydrogen sulfide and organic acid emissions.

In order to protect human health and the possibility of pathogen contamination from any solids leaving the property, the object of eliminating BOD or nutrient contamination by treating liquids and solids as they are produced is expected to meet this objective.

An important objective of the invention is to maximize the value and quality of the by-products produced from the process and to meet all current and prospective environmental regulations for waste handling at animal feeding operations.

It is to be understood that the invention covers a process that involves the use of a series of known and established types of equipment, but, that the invention specifically relates to the manner in which each piece of equipment relates to the present process and methods to allow for an effective, and reliable system for re-use and recycle of treated liquid streams, that can be stored or land applied, and are free from environmental concerns, and, creates a bacterial conversion to biomass suitable for feeding and fertilizers that have low-leachability and are disinfected.

### BRIEF DESCRIPTION OF THE DRAWINGS

For a full and complete understanding of the nature and objects of the invention, references should be made to the following detailed description taken in connection with the accompanying drawings, wherein;

Drawing sheet one (1/2) is a block process flow diagram illustrating the preferred embodiment of the present invention;

Drawing sheet two (2/2) is a block process flow diagram illustrating an alternative embodiment utilizing a common dewatering and drying mechanism for use after both biological treatment and the manure solids separation, requiring two pretreatment tanks.

### DETAILED DESCRIPTION

In the following detailed description, the example of high volume swine feeding operation is used for illustrative purposes only. It will be clear to those of ordinary skill in the art, that the present invention is applicable to most livestock production facilities, concentrated animal feeding operations or agricultural wastewaters generally. Illustration 1 of 2 is a preferred embodiment of the invention.

Wastewater is flushed (transported) 10 from the production buildings to a de-gritting device 1 that removes the heavy non-fecal grit 11 from the flush water waste stream. The grit-free slurry 12 is transported to a stirred mix-tank 2 which acts as an equalization surge-tank to normalize the flow to the dissolved air flotation unit and act as a reaction vessel for the metered addition of a metal-acid solution 13 used to aid in coagulation and flocculation and to adjust the pH of the entire volume within the mix-tank.

The pH adjusted, phosphate treated and partially coagulated waste stream 14 is then transported through an in-line flocculation device 3 used to introduce flocculating agents 15 to the manure slurry in proportion to the flow rate of the wastewater 16 before it enters the dissolved air flotation device 4, where the manure solids are removed from the liquid stream through flotation and transported 18 to a fixed volume device 5, and the solids-free liquid not required to maintain water balance in the recycle loop is pumped 33 to the biological treatment system 7.

Pre-treatment de-watering chemicals 19 and flocculating chemicals 20 are metered either in-line or added in proportion to the flow rate in 5, and the flocculated manure slurry 21 is fed and dewatered in the first phase of a combination pressure dewatering vacuum drying filter press (VFP) 6. The flocculated and chemically treated manure slurry, is pumped under pressure into cloth-lined filter-plate cavities, where solids are retained and the filtered liquid exits the press as filtrate and is returned to the flush waste stream 22 or is added 35 with the excess flush water 33 for phosphate control of water entering the biological treatment process. In the second phase of the VFP process, the wet cake formed from the pressure de-watering phase is subjected to heat and vacuum and the residual vapors removed are re-condensed. They are added 23 to the grit-free slurry 12 going to the equalization and mix-tank 2.

Once the drying is completed in the second phase of the VFP process the press is opened, and the dried, disinfected (organic) manure solids are discharged from the cloth lined cavities 39. The press is then re-set for another cycle.

The solids-free excess flush water fraction plus any filtrate water from the dewatering phase of the VFP not returned to the flush water system is transported 33 and enters the aeration chamber 36 of the biological treatment system.

The biological treatment system of the preferred embodiment is an intermittent-cycle, extended-aeration system, composed of a complete-mix, complete-oxidation, modified batch process. The initial treatment of aeration, mixing, and oxidation with sludge that is recycled in the treatment process takes place in the aeration chamber. Microorganisms aerobically stabilize incoming organic matter, which is stored as activated sludge in the aeration chamber. The activated sludge, while in the aeration tank, enters into an advanced aerobic stabilization mode, which is comparable to the aerobic digestion process. This mode, called reaction, gives rise to the process term “batch reactor”. The advantage of the reactor process is found in the enhanced reduction of volatile suspended solids without affecting the development of those organism types required for the basic process. Prior to transfer of a portion of the nitrified mixed liquor from the aeration tank, the aeration is stopped to allow for gross de-nitrification. Following gross de-nitrification, a portion of the aeration volume is batched to the clarifier tank 37. Sedimentation, or clarification, follows the aeration process. This stage allows the activated sludge to flocculate and settle out, producing a clear effluent of low organic content.

After transfer of a portion of the clarified supernatant to the contactor (disinfection) tank 38, the remaining settled sludge and supernatant is allowed to further denitrify before being returned to the aeration tank as activated sludge. When the settled sludge exceeds a certain level a portion is “wasted” and transferred 26 from the unit. After the supernatant has been transferred from the clarifier to the disinfection 38 step it undergoes ozone treatment and the treated water 25 is pumped to irrigation or direct discharge.

The wasted microorganisms from the biological treatment system are pumped 26 to a fixed volume pre-treatment tank 8. Pre-treatment de-watering chemicals 27 and flocculating chemicals 28 are metered in, either in-line or added in proportion to the flow rate in 8, and the flocculated biosolid 29 is fed and dewatered in the first phase of a combination pressure dewatering vacuum drying filter press (VFP) 9. The flocculated and chemically treated biomass slurry, is pumped under pressure into cloth-lined filter-plate cavities, where solids are retained and the filtered liquid exits the press as filtrate and is returned 30 to disinfection in the biological treatment system 38. Once the drying is completed in the second phase of the VFP process the press is opened, and the dried, disinfected organic biosolids feed material is discharged from the cloth-lined cavities 31. The press is then re-set for another cycle.

Illustration 2 is similar to the primary embodiment described in detail above, except for the following changes due to consolidation of the dewatering and drying equipment shown in this embodiment. The initial differentiation between the two embodiments is following DAF treatment 4 wherein the manure solids 18 are transported and then stored 34 prior to being transferred 41 to pretreatment 8 and undergoing dewatering and drying in the VFP 9. This is necessary because only one dewatering and drying filter press (VFP) is shown in illustration 2. When filtrate leaves the VFP 30 after pressure dewatering, it will be transported 30 back to either the equalizing mixing tank 2 when manure is dewatered, or be transported 30 back to disinfection 38 when biosolids are being dewatered. In addition as the biomass is pumped from the biological treatment system clarifier 37 it too must be transported 24 and stored in biosolids storage tank 32, prior to being transferred 40 to the vacuum filter press pretreatment 8.

This particular embodiment of the invention can be utilized for smaller animal feeding operations, or in a less automated fashion alternating between biomass (feed) production and organic fertilizer (manure) production.

We claim:

1. An apparatus for treatment of animal manure and wastewater, said apparatus comprising in combination:
a means of providing conditioned re-cycle flush water, through pretreatment and solids separation, for waste fluming;
a contaminated wastewater source connected in fluid flow communication with said means of conditioning;
a means of processing the reject material from the re-cycle flush wastewater;
whereby said reject material is treated in order that it can be re-cycled with reduced environmental impacts and/or can be beneficially re-used.

2. The treatment apparatus as in claim 1, further comprising a mechanical screening device or a de-gritting device to remove non-fecal grit from the flush water waste stream prior to treatment of the recycle waste stream.

3. The treatment apparatus as in claim 1, further comprising a mixed equalizing and reaction vessel device, where the wastewater re-cycle flush water is mixed with a precipitating metal-salt acid solution to maintain pH of the solution, to suppress or eliminate ammonia releases to the atmosphere (de-gassing), and to remove a portion of the soluble o-phosphate as insoluble metal-phosphate, providing coagulation to assist the liquid-solids separation that follows and to normalize down-stream flows.

4. The treatment apparatus as in claim 1, further comprising a flocculation device, to add flocculant to the wastewater stream to increase the efficiency of the liquid/solid separation prior to re-cycle as flush water.

5. The treatment apparatus as in claim 1, wherein the means of providing conditioned re-cycle is further described as a dissolved air flotation (OAF) device, where the flocculated manure solids are separated from the re-cycle flush water, and dissolved oxygen is added to prevent anaerobic conditions, and includes a receiving vessel for conditioned water from the DAF for return to waste fluming, which automatically reject the excess water volume from the re-cycle flush water.

6. The treatment apparatus as in claim 1, wherein the liquid reject is further processed using a biological treatment system.

7. The treatment apparatus as in claim 1, wherein the reject manure solids are further processed for stabilization.

8. The treatment apparatus as in claim 7, wherein the reject manure solids are stabilized using an apparatus further described as:
a preconditioning device to flocculate the manure solids to allow for dewatering, said preconditioning system to be an in-line or batch process whereby a multiple chemical feed system mixes the flocculation chemicals with the reject manure solids at proper ratio;
a combination filter press vacuum drier (VFP) device, in fluid flow communication with the preconditioning device to pressure dewater the reject manure solids as they are fed into the VFP to produce a wet cake, with a filtrate return system from said VFP, wherein the liquids fraction separated in the pressure dewatering step is returned to the recycle loop and/or a biological treatment system as in claim 14, and the wet cake formed during the pressure dewatering phase is dried through the application of heat and vacuum, resulting in a relatively dry, disinfected organic fertilizer and the vapor water removed is re-condensed and returned to the recycle loop;

9. The treatment apparatus as in claim 6, wherein the biomass produced is further process to produce a biomass feed or biomass fertilizer;

10. The treatment apparatus as in claim 9, wherein the biomass solids are further processed utilizing:
a preconditioning device to flocculate the biomass solids to allow for dewatering, said preconditioning system to be an in-line or batch process whereby a multiple chemical feed system mixed the flocculation chemicals with the biomass at proper ratios;
a combination filter press vacuum drier (VFP) device, in fluid flow communication with the preconditioning device to pressure dewater the reject manure solids as they are fed into the VFP to produce a wet cake, with a filtrate return system from said VFP, wherein the liquids fraction separated in the pressure dewatering step is returned to the recycle loop and/or a biological treatment system as in claim 14, and the wet cake formed during the pressure dewatering phase is dried through the application of heat and vacuum, resulting in a relatively dry, disinfected organic fertilizer and the vapor water removed is re-condensed and returned to the recycle loop.

11. The treatment apparatus as in claim 6, said apparatus comprising an intermittent-cycle extended aeration system (ICEAS) using a complete-mix, complete-oxidation, modified-batch process to meet discharge requirements.

12. A method for controlling phosphate concentrations in the liquid wastewater treated in the biological treatment system to prevent residual in the treated effluent without inhibiting cell growth within the process stream by;
diverting a portion of the phosphate-free filtrate from the manure dewatering device, directly to the biological treatment unit, until the excess level of phosphate no longer show a residual in the effluent from the biological treatment system if there is residual requiring a reduction in phosphate in the biological treatment system;
increasing the acid to metal-salt concentration of the solution used in the equalization tank for pH control if there in insufficient phosphate in the feed for proper bioactivity;
operating the DAF in a manner, so that the manure float material contains a larger water ratio, as an alternative, thereby reducing phosphate residual to the biological treatment system, until the excess level of phosphate is controlled.

13. A method for controlling ammonia de-gassing in flush water, or flush water conditioning for animal feeding operations consisting of:
use of a pH probe in the equalization mix tank;
adjusting the ratio of acid to metal-salt concentration such that a desired pH set point is achieved;
lowering the set point until ammonia is no longer being volatilized from the liquid;
maintaining this pH set point (between 6.5 and 7.5);
thereby controlling ammonia de-gassing in the flush water.

14. A method for controlling odors from animal feeding operations, said method uses a dissolved air flotation unit (DAF) designed with the proper feed to circulation ratio to ensure flush water being saturated with dissolved oxygen (DO), and all sumps, and equalization vessels are sized sufficiently small, and have relatively short residency periods, such, that there will be no anaerobic breakdown of wastes to reduced sulfur compounds, organic acids or other septic type odors.
